(19) United States
(12) Patent Application Publication
(10) Pub. No.: US 2026/0040077 A1
(43) Pub. Date: Feb. 5, 2026

(54) MOBILE DYNAMIC THIN FIREWALL FOR ADVANCED CELLULAR NETWORKS

(71) Applicant: AT&T Intellectual Property I, L.P., Atlanta, GA (US)

(72) Inventors: Joseph Soryal, Glendale, NY (US); Venson Shaw, Kirkland, WA (US)

(73) Assignee: AT&T Intellectual Property I, L.P., Altanta, GA (US)

(21) Appl. No.: 18/794,015

(22) Filed: Aug. 5, 2024

(51) Int. Cl. H04W 12/088; G16Y 30/10; H04W 8/18; H04W 12/122

(52) U.S. Cl. CPC H04W 12/088; H04W 8/18; H04W 12/122; G16Y 30/10

(57) ABSTRACT

Aspects of the subject disclosure may include, for example, instantiating a local dynamic firewall module at a network node of a mobility network, the local dynamic firewall module providing firewall services to a firewall service area, detecting communication activity of a subscriber device, the subscriber device having a subscription to the firewall services, communicating information about the communication activity of the subscriber device to a central firewall controller, receiving, from the central firewall controller, information defining a threat response, the information defining the threat response determined by the central firewall controller responsive to the communication activity of the subscriber device, a subscriber profile associated with the subscription to the firewall services, and additional information related to possible security threats detected by the central firewall controller, and limiting communication activities of the subscriber device based on the information defining the threat response from the central firewall controller. Other embodiments are disclosed.

### FIELD OF THE DISCLOSURE

This disclosure relates generally to the field of data protection in communication systems. More particularly, this disclosure relates to a mobile, dynamic thin fire wall that may be applied to next-generation cellular networks.

### BACKGROUND

With the expansion of fifth generation (5G) and the incoming of sixth generation (6G) cellular networks, a communications environment will have multitude of nodes. Each active device on the network, including elements of network infrastructure, correspond to a node in the network. Each geographical area will host thousands of internet of things devices (IoTs), vehicles traversing the geographical area, robots, drones, and other devices. Each device raises an issue of data security for the device and the network. In the aggregate of all devices, the issue becomes very significant.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a diagram illustrating an example, non-limiting embodiment of a firewall system in accordance with various aspects described herein.

FIG. 2C is a diagram illustrating an example, non-limiting embodiment of a mobile communication system in accordance with various aspects described herein.

FIG. 2D and FIG. 2E depict an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for an intelligent, dynamic firewall (IDFW) to be deployed autonomously in a geographical area in a cellular network, in a distributed manner. The IDFW can reside with the radio access network or edge network infrastructure. The IDFW may be instantiated by a backend orchestrator's main application. The main application collaborates with a local IDFW module. The IDFW recognizes subscribers who are registered to use the firewall service. Each subscriber has a profile defining security needs and traffic requirements. Other embodiments are described in the subject disclosure.

One or more aspects of the subject disclosure include instantiating a local dynamic firewall module at a network node of a mobility network, the local dynamic firewall module providing firewall services to a firewall service area, detecting communication activity of a subscriber device, the subscriber device having a subscription to the firewall services, communicating information about the communication activity of the subscriber device to a central firewall controller, receiving, from the central firewall controller, information defining a threat response, the information defining the threat response determined by the central firewall controller responsive to the communication activity of the subscriber device, a subscriber profile associated with the subscription to the firewall services, and additional information related to possible security threats detected by the central firewall controller, and limiting communication activities of the subscriber device based on the information defining the threat response from the central firewall controller.

One or more aspects of the subject disclosure include instantiating a local firewall module at a network node of a mobility network, the network node providing communication services to a service area, detecting, by the processing system, presence of a subscriber device in the service area, retrieving a subscriber profile for the subscriber device from a central firewall controller, wherein the retrieving is responsive to the detecting the presence of the subscriber device in the service area and wherein the central firewall controller cooperates with the local firewall module to provide firewall services for the subscriber device according to the subscriber profile, detecting communication activity of the subscriber device, communicating information about the communication activity of the subscriber device to the central firewall controller, receiving information defining a threat response from the central firewall controller, the information defining the threat response determined by the central firewall controller responsive to the communication activity of the subscriber device and additional information related to possible security threats collected by the central firewall controller, and modifying communication activities of the subscriber device based on the information defining the threat response from the central firewall controller.

One or more aspects of the subject disclosure include receiving information about a subscriber device in a mobility network, communicating, to an edge node, information to establish at the edge node a local dynamic firewall for the subscriber device, receiving, from the edge node, information about communication activities of the subscriber device, identifying a security threat to the subscriber device, wherein the identifying the security threat is responsive to the information about communication activities of the subscriber device and information about other security threats identified in the mobility network, determining a threat response for the subscriber device, wherein the threat response is intended to avoid malicious effects of the security threat to the subscriber device, and communicating information about the threat response to the subscriber device.

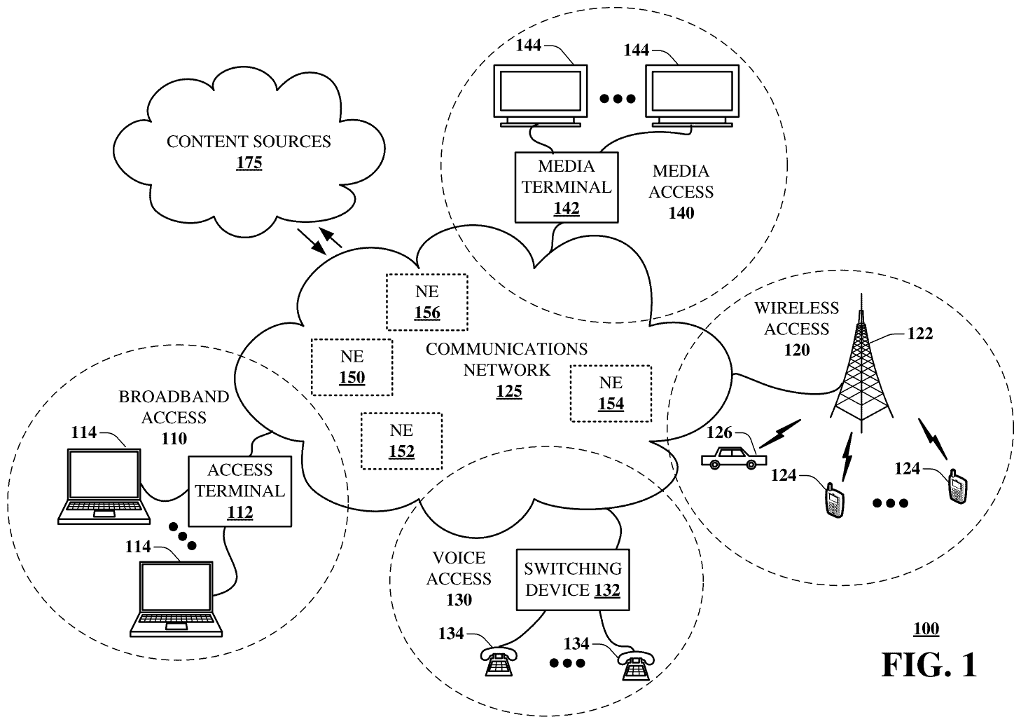

Referring now to FIG. 1, a block diagram is shown illustrating an example, non-limiting embodiment of a system 100 in accordance with various aspects described herein. For example, system 100 can facilitate in whole or in part establishing a local dynamic firewall for subscribers that interacts with a backend orchestrator to dynamically create and update a firewall service. The firewall service moves with and adapts to the activity of the user device. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VOIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

Communications networks such as those illustrated in FIG. 1 continue to expand to provide service and access to increasing numbers of subscribers or customers. Moreover, new types of networks are being developed, using advanced technologies. Examples are fifth generation (5G) and sixth generation (6G) cellular or mobility networks. With the expansion of 5G and the incoming of 6G, the environment will have a multitude of network nodes, where each device and each network infrastructure element corresponds to a network node. Each geographical area will host thousands of Internet of Things devices (IoTs), vehicles, robots, drones, and other devices, passing through the geographical area. There is thus a wide variety of device types, in addition to increasing numbers of device. Each device represents a risk to data security for the device itself and for the network for which the device forms a node.

Some elements of network security, to limit unauthorized access to the network and network resources, is necessary. There is no single security posture or policy to enable telecommunications carriers to implement a firewall that covers all these different types of devices with their various applications and distinct behavior. There is a developing need for a dynamic, on-demand, mobile firewall layer that resides at the network edge to cover the different needs of the devices operating in a geographical area.

Conventionally, a mobility network provides security at two levels. At a first level is a device-based firewall. A firewall is a part of a computing system, either software or hardware or a combination of these, that is designed to block unauthorized access while permitting outward communication from the computing system to a network. In this case, the mobile device includes a computing system for processing data and instructions and communicating over one or more networks. The device-based firewall, however, only protects the device on which it operates. On the other hand, a second level of protection is a network-based firewall. The network-based firewall covers many, many devices. With the conventional scheme, the user and user devices either get very personalized protection or very generalized protection. Neither option may be the best fit.

In an example, a network security researcher may use a software tool that analyzes network traffic in real time for different operating systems. The tool operates to capture data packets passing through a network interface and translates that data into useful information for the network security research to analyze. The tool may be termed a packet sniffer or network protocol analyzer. Tools such as this intercept network traffic to understand the activity being processed and develop insights.

In some instances, activity by a packet sniffer may be detected and flagged by a network protection tool such as an anti-virus detector. A network-based firewall will likely flag the packet sniffer activity as a potential security threat if the security researcher attempts to connect to the packet sniffer website or server. Such a response appropriate for a standard network user. However, the flagging response is excessive when the security researcher seeks to investigate the use of the device. That is, the network-based firewall is generalized and does not cater to each user's requirements or preferences.

Similarly, the firewall or antivirus software on a user device just evaluates data crossing the device's network threshold and flagging potential intrusions according to user settings or selections. The local antivirus does not have a broader perspective of potential security threats or concerns.

Accordingly, there is a need for a security service that fits in between the device firewall and the network firewall. This may be a tool that is targeted to a relatively small number of users that share a characteristic, such a team of work collaborators or researchers, or members of a family. The tool monitors everyone's security perimeter individually. At the same time, the tool has a macro-level vision to understand a broader scope of threats or to understand the context of a localized threat and respond accordingly.

A security tool or firewall in accordance with various aspects described herein may include a strong geographic focus or operational characteristic. The tool may be applied to all mobile devices at a traffic intersection, or located on a particular city block, or in a sector of a village. The tool protects all devices in the defined geographical area. The tool is available to users on demand, rather than up and running all the time. For example, if the tool covers devices in a factory that operates from 8:00 AM until 5:00 PM, the tool is up and active during those hours and turns down and becomes inactive outside those hours. If the tool covers one or more vehicles, the tool becomes active at 5:00 PM for the drive home, then becomes inactive when the vehicle is parked overnight until the return commute the next day. In another example, if a user knows that a particular model of IoT device is to be delivered from a factory to the user facility, and the user has prior knowledge of a particular vulnerability of the model of IoT device to a particular security attack, the user can elevate protection against the particular threat for the devices even before the devices arrive to preemptively create a protective shield or firewall around the devices. Thus, the tool is very dynamic and very localized.

In embodiments, the tool or service is located at a network edge or the edge. Generally, a network includes three levels of device. The network includes data centers and cloud-based services. A mobility network such as a 5G or 6G network or beyond may include a core network. The core network implements a number of functions such as mobility management, accounting and authorization, and a gateway to the public internet and other networks. The device level of the network includes just a user device, such as a smartphone or IoT device or connected car, with access to a network for communication. The edge is functionally and structurally in between. The edge device may be geographically local to the user. An example may include smart boxes at the end of a street, on poles along the street. The network edge is the point where a device or local network communicates with the internet or other network. This could be a user's computer, the processor in an IoT device such as a camera, a router, an internet service provider (ISP), or a local edge server. The edge is geographically close to the device, unlike cloud or origin servers.

In accordance with various aspects described herein, an Intelligent Dynamic Firewall (IDFW) may be deployed autonomously in a geographical area in a distributed manner and may reside with open radio access network (ORAN) or Edge electronics. ORAN is a modular access network architecture. The modules are flexible and may be used on demand or intermittently and may have idle times. A geographic region that includes ORAN facilities may incorporate those ORAN components or functional modules into the IDFW.

As noted, the IDFW serves to provide security features to a particular geographical area, such as a building or portion of a building, a neighborhood or a traffic intersection. The IDFW may be defined to operate over a particular time period or as needed. The IDFW and its functionality are flexible as to time and place of availability.

In an example, the IDFW firewall may include a number of functional modules, such as packet analyzers and a signature matching service. The functional modules may be distributed among several or many user devices and among local ORAN components. Each device has one or more functional modules capable of communication among other modules of the IDFW firewall. In the aggregate, the modules form a single, powerful firewall.

In embodiments, the IDFW firewall covers and protects different types of communications. A first type of communication covered by the IDFW firewall is communication between a network node and a network core. The network node may include any device active on the network such as a mobile smartphone, an IoT device, a connected vehicle, etc. The network core implements a number of important functions such as mobility management. A second type of communication covered by the IDFW firewall is peer-to-peer communication between nodes or devices in the network, such as connected vehicle to connected vehicle, IoT device to connected vehicle, etc.

Moreover, peer-to-peer communications may include communications among users defined to be peers. Examples include coworkers on a project or family members. Still further, the members of the peer group may be divided into subgroups. One subgroup may be considered to require a higher degree of firewall protection, perhaps because they are directly involved in security research and testing vulnerabilities. The members of that subgroup may be assigned a higher degree of firewall protection. In general, for the group members, not all geographical locations are the same, not all the devices are the same and not all the users are the same. Therefore, the autonomous firewall may be dynamically put in place to protect members.

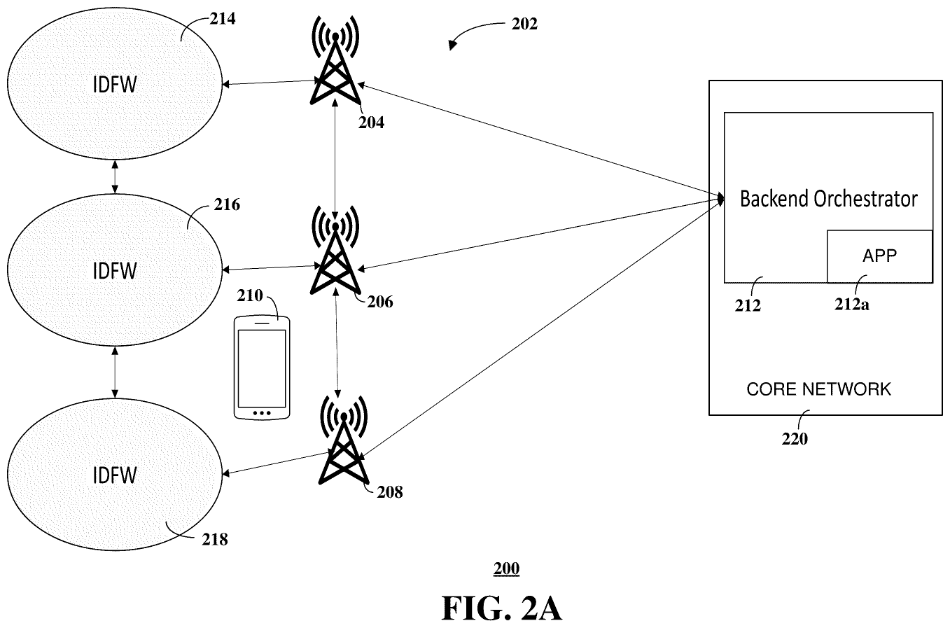

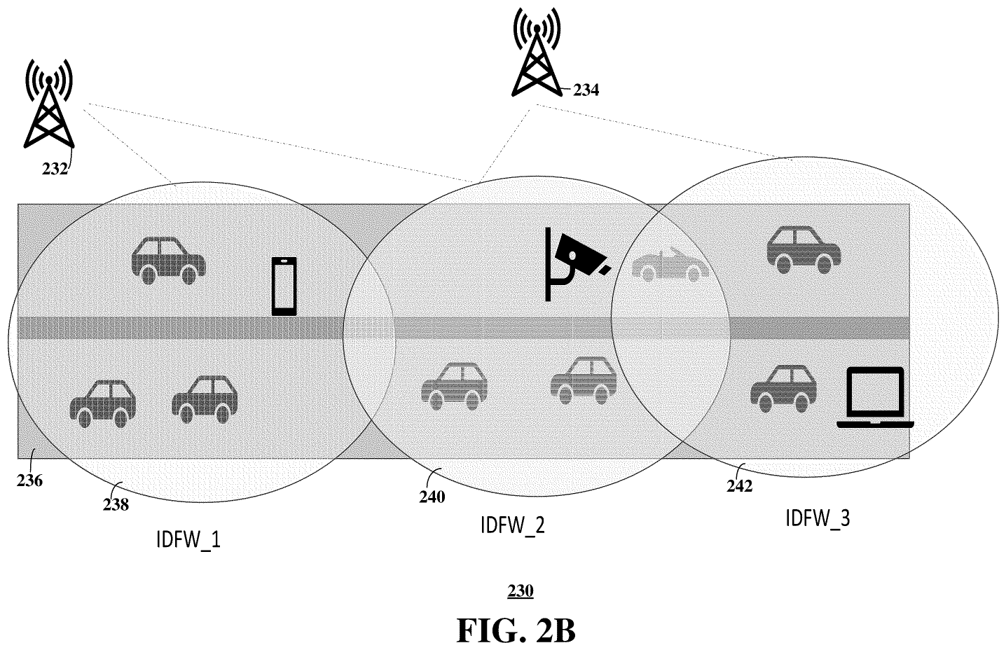

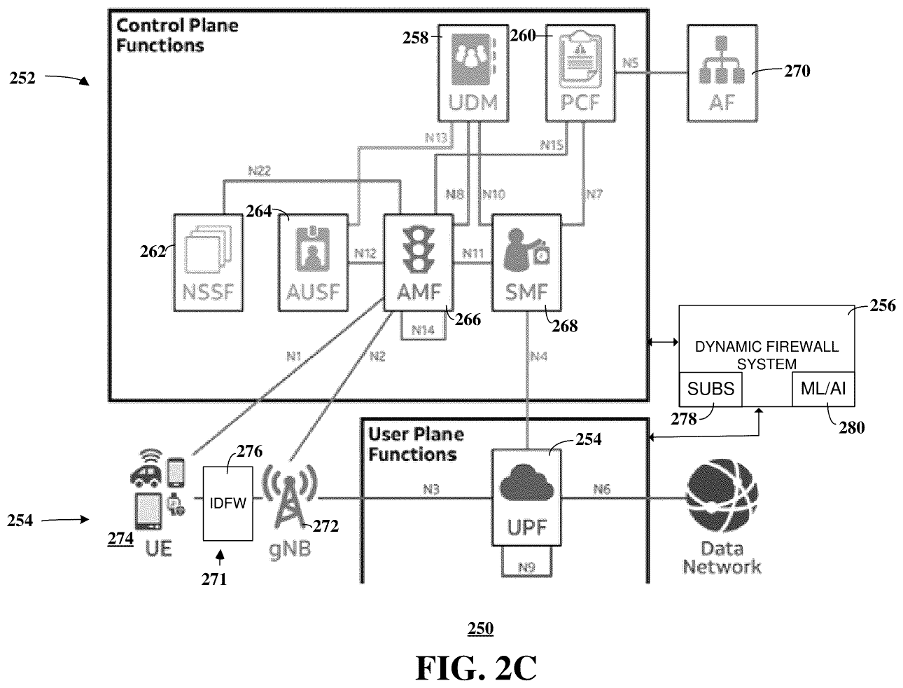

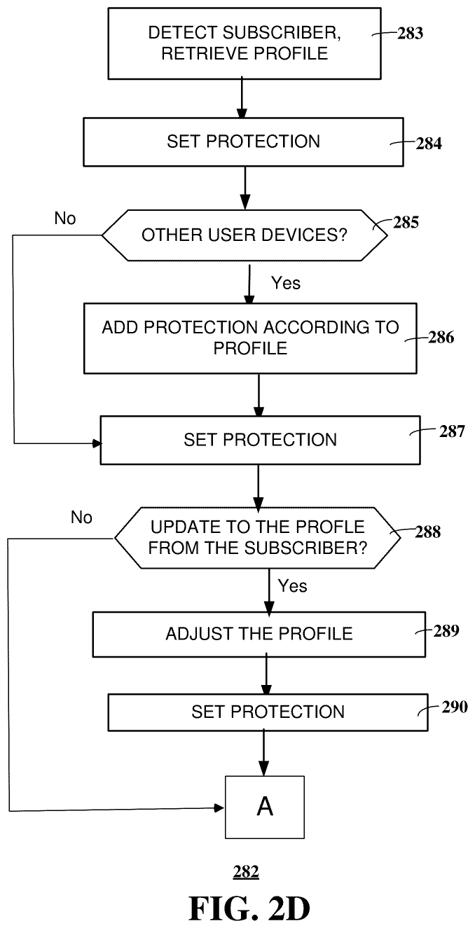

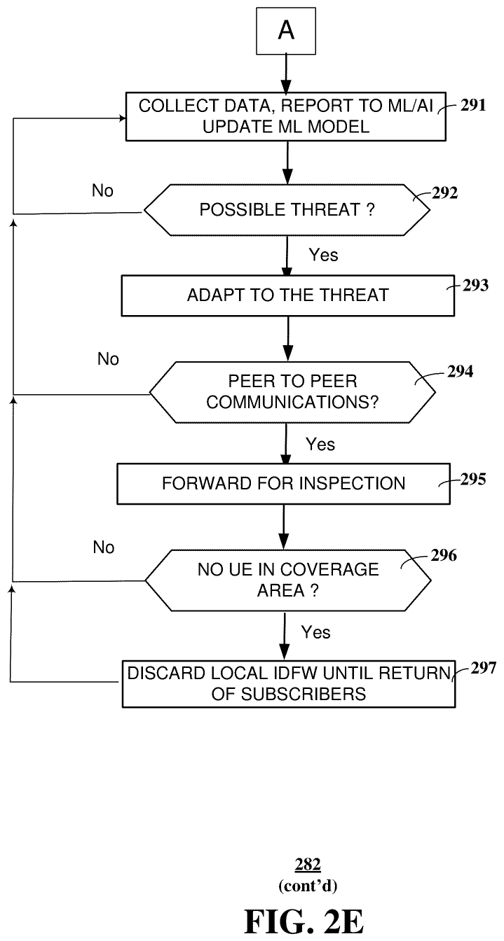

FIG. 2A is a block diagram illustrating an example, non-limiting embodiment of a system 200 functioning within the communication network of FIG. 1 in accordance with various aspects described herein. The system 200 may cooperate with any network elements (NE) 150, 152, 154, 156, etc., illustrated for example in FIG. 1, which enable the broadband access 110, the wireless access 120, the voice access 130, the media access 140 and combinations thereof.

In the example embodiment of FIG. 2, the system operates in conjunction with a wireless network 202 including base station 204, base station 206 and base station 208. The wireless network 202 provides mobile communication services to user equipment such a user device 210. The wireless network 202 in some embodiments includes an Open Radio Access Network (ORAN). ORAN is a nonproprietary version of a radio access network system that allows interoperation between cellular network equipment provided by different vendors. The wireless network 202 may operate according to a published air interface standard such as the fifth generation (5G) cellular standard, the sixth generation (6G) cellular standard or other alternative or follow-on standards. Each base station, including base station 204, base station 206 and base station 208 provides wireless communication service to user equipment such as user device 210 in the geographical area served by the base station. There may be overlap in service areas and communication may be handed off from one base station to another as the user device 210 moves through an area. The base stations may be in communication with a core network 220 via a backhaul data connection. The core network 220 implements network functions such as mobility control, authorization and accounting and gateway access to the public network.

In accordance with various aspects described herein, the system 200 implements an intelligent dynamic firewall (IDFW) in connection with each base station, including base station 204, base station 206 and base station 208. In the example, IDFW 214 is associated with base station 204, IDFW 216 is associated with base station 206, and IDFW 218 is associated with base station 208. Moreover, each IDFW is associated with a backend orchestrator 212. The backend orchestrator 212 may be implemented at the core network 220 as shown in FIG. 2A or at any other suitable network component such as a data center.

An IDFW such as IDFW 214 may be implemented in any suitable fashion. In general, as noted, the IDFW resides on an edge node. In the example, an IDFW module resides on the base station 204. The module may include any suitable hardware or software. In an example, the IDFW module is all software and includes a portion of code and data that run on the data processing system which controls operation of the base station 204. The IDFW module shares other resources of the base station 204, including the backhaul channel to the backend orchestrator 212 and a radio access network which provides mobile communication service to user equipment served by the base station 204, such as user device 210.

In another example, an IDFW such as IDFW 216 may be collocated with a base station such as base station 206 but operates autonomously from the base station 206. In this example, the IDFW 216 has its own communication resources for communicating with user equipment such as user device 210 and for communicating with the backend orchestrator 212.

In yet another example, an IDFW such as IDFW 218 may be located away from a base station such as base station 208 and instead be mounted inside a building such as a factory or office building or be mounted outside along a street such as on a utility pole. Again, in this example, the IDFW 218 has its own communication resources.

The backend orchestrator 212 controls and manages the dynamic firewall service implemented by remotely located IDFW modules. In the exemplary embodiment, the backend orchestrator 212 includes an application 212a. In some embodiments, users may subscribe to a firewall service. The firewall service may be controlled by a user application resident and operating on the user's mobile device or other user equipment. For example, the user may establish a profile defining security needs and preference of the user as well as traffic requirements and other information to control the service for the user. The user application on the user device may communicate with and cooperate with the application 212a of the backend orchestrator.

In operation, the backend orchestrator provides the local application at the edge node or at an ORAN device. The IDFW such as IDFW 214, IDFW 216 or IDFW 218, gets spun up by a main firewall application operating at the backend orchestrator 212. For example, the backend orchestrator may run software including programming code which causes the backend orchestrator to communicate with the IDFW module. Communication may be in any suitable form, such as wirelessly or over a wire such as the backhaul connection from a base station such as base station 204. An initial communication from the backend orchestrator operates to activate or initialize the operation of the IDFW module. The main IDFW application 212a at the backend orchestrator 212 cooperates with the IDFW module.

Further, the backend orchestrator 212 including the application 212a gathers information and further distributes information to the local IDFW modules. The backend orchestrator 212 has global visibility of the wireless network 202 and other assets of the network operator associated with the wireless network 202. For example, the backend orchestrator 212 knows geographical locations of edge nodes, base stations and other locations where local IDFW modules are located. Moreover, the backend orchestrator 212 has current information about activity in the network. This may include numbers of subscribers or other users active on the network, the network locations of those subscribers and users, and information about activities of the subscribers and users. Based on this information, the backend orchestrator 212 may decide to instantiate a firewall at a particular edge node. Still further, based on this information, the backend orchestrator 212 may device to take down an existing firewall.

The local IDFW modules at the edge nodes communicate with each other directly. First, the local IDFW modules may operate to share information. For example, one local IDFW module may determine that a vehicle with an IoT device is attempting to establish a DDOS attack on one or more users. The IDFW module may identify the vehicle and its network credentials and inform other IDFW modules nearby, as well as the backend orchestrator 212. In another example, an IDFW module will determine that several IoT devices are acting improperly after receiving packets from a particular suspicious server. The IDFW module will notify other IDFW modules of the incident as well as the identity, such as a network address, of the suspicious server. Other IDFW modules will respond to this information by blocking further contacts from the suspicious server with protected user devices.

Further, the local IDFW modules operate to provide information to the mobile user or the user device such as user device 210 for example, for secure session continuity. The IDFW responds to information provided in a profile by a subscriber to the firewall service. The subscriber may be an individual user who desires firewall protection for a mobile phone. Further, the subscriber may add a laptop computer to the subscription for firewall protection for that device. Still further, the subscriber may add other devices associated with or used by the subscriber, such as IoT devices in the subscriber's home or workplace, a connected vehicle device, and others as well. The firewall protection may extend to devices that communicate over a wireless network such as wireless network 202 and also to other types of networks such as a broadband network, a voice network, a satellite network, and others. In another example, the subscriber may be a business or other entity that has a number of IoT devices operating statically in a facility or mobile. The subscription may cover a large number of IoT devices.

Based on the subscription information, the subscriber's profile, or a combination, the local IDFW module as well as the backend orchestrator 212 is aware of requirements and capabilities of the user device and the current situation. The backend orchestrator 212 provides a threat response to the local IDFW module. The threat response may be tailored to capabilities or capacities of the user device. For example, the IDFW devices have awareness that a particular subscriber device is an IoT device and thus has very limited processing power, communication abilities, memory and mobility. This can be useful for the firewall service for detecting potential threats. For example, if an unknown server is attempting to give a task involving substantial mathematical computations to an IoT device, which has limited processing power, which raises suspicions. Similarly, if an unknown source tries to command a connected vehicle to download new software while the vehicle is underway on a journey, that also raises suspicion. The source of such signaling is potentially malicious.

FIG. 2B is a diagram illustrating an example, non-limiting embodiment of a dynamic firewall system 230 in accordance with various aspects described herein. In the example, the dynamic firewall system 230 is implemented by a first base station 232 and a second base station 234 positioned along a roadway 236. In embodiments, the base station 232 and base station 234 include or are supplemented with an edge node which is in data communication to a central firewall controller such as the backend orchestrator 212 of FIG. 2A.

In the illustrated example, the dynamic firewall system 230 has established three dynamic firewalls, including a first firewall 238, labelled IDFW_1 in FIG. 2B; a second firewall 240, labelled IDFW_2; and a third firewall 242, labelled IDFW_3. In this example, the first firewall 238 covers several devices including vehicles and a user's smartphone. Similarly, the second firewall 240 covers several other devices including vehicles and an IoT device in the form of a security camera. Further, the third firewall 242 covers vehicles and a user's laptop computer. These are meant to be exemplary only and any suitable number of devices and types of devices may be covered by a firewall.

Each respective firewall covers a respective geographic area, indicated by the circular shapes in the figure. The geographic areas are not fixed. For example, if only two vehicles are on a road portion 50 miles long, the firewall could be stretched to cover both of them as a single geographic area, despite the separation distance. In such a case, multiple cell towers or edge nodes along the roadway 236 cooperate to provide the dynamic firewall. Thus, a cell tower such as base station 232 or base station 234, or an edge node, manages more than one firewall or, in some examples, two or more cell towers or two or more edge nodes together manage a single firewall. Thus, the firewalls are totally dynamic in number as well as in size and shape of the geographic area covered.

A firewall is said to cover an area where the dynamic firewall system 230 provides firewall services to devices in that area. The protection may be limited to subscribers to the firewall services. Moreover, the protection may be applied to various devices of a subscriber, including a smartphone, a connected vehicle, a laptop computer and an IoT camera. Each respective device includes a firewall module, which may be software, hardware or a combination of the two.

Each firewall module is in communication with a central firewall controller such as the backend orchestrator 212 (FIG. 2A). The central firewall controller establishes the firewall for a subscriber or other user. The firewall, or firewall services, may cover the user's devices even when those devices are not physically with the user or in the same location. Thus, in an example, the user has a security IoT camera at home. The user leaves a laptop computer at the user's worksite. The user parks the vehicle at the airport during a trip and carries the smartphone on the trip. All the covered devices are in different locations, but the firewall dynamically and flexibly extends to cover all the devices, independent of their current location. Further, if one or more of the subscriber's devices is powered off or otherwise taken offline or out of a protected state from the dynamic firewall system 230, the other devices of the subscriber remain covered by the dynamic firewall system 230.

Further, the central firewall controller establishes the firewall according to the needs, requirements and capabilities of each protected device. As noted, a threat may be determined based on an inappropriate command or request to a device, such as a command to perform substantial mathematical calculations by a lightly equipped IoT device such as the video camera. In another example, the central firewall controller maintains information about each device such as a manufacturer and a model number. Further, the central firewall controller is constantly receiving up to date information about detected threats to devices, including to protected devices. In this example, a particular threat, such as attempted installation of malware, is detected as being aimed at a particular model number of video camera made by a particular manufacturer. The central firewall controller may process the threat information, identify common properties of threatened devices and identify any protected devices having the same or similar properties and associated with a subscriber. The central firewall controller may then dispatch a firewall protection update to the identified, protected devices. The update may identify the nature and source of the threat and specify protective actions to be taken. Any suitable protective actions may be provided, such as ignoring commands and communications from a particular source, disabling certain actions by the protected device or even shutting the protected device down, into an off state, for a set period of time. The firewall module for the device is tied intimately to controlling software and hardware of the device on which the firewall module is resident to enable such a degree of control of the device.

In embodiments, the dynamic firewall system 230 includes a machine learning or artificial intelligence (ML/AI) function. The ML/AI function may be implemented, for example, at the central firewall controller or backend orchestrator 212. The ML/AI function collects information from all available sources and uses the collected information to identify security threats that may affect a protected device, to develop a response to the threat, and to provide information and commands to local firewall modules at individual devices to protect against the threat. For example, each local firewall module reports to the ML/AI function all pertinent information the local firewall module receives, about activity performed by a protected device, about data communication traffic received at and transmitted from the protected device and even environmental information about a protected device. For example, the local firewall module for a connected vehicle may report information about current vehicular traffic as well as sidelink communications between the connected vehicle and other vehicles, infrastructure and people. Such information is collected by and processed by the ML/AI function at the central firewall controller to identify patterns in the information. Moreover, the ML/AI function may have access to information stored on user devices, such as a user's messages and email, a user's calendar and contacts. This information may be processed by the ML/AI function to identify potential or future threats which may affect a device of the user. The ML/AI function may generate a prediction of current or future security threats to one or more devices of the user.

The ML/AI function may be implemented in any suitable manner. In one example, the ML/AI function includes a machine learning model which is trained on historical threat data and used for pattern matching with current user device activity to identify potential threats. As new threats are identified, the new threat information is used periodically to re-train the machine learning model in order to update the machine learning model to reflect and detect the latest attempts to circumvent the dynamic firewall system 230. In embodiments, user data may be shared among users and by the ML/AI function and the user data may be anonymized prior to sharing, in order to maintain confidentiality of the information. Further, in some embodiments, the user may opt out of some aspects of data sharing, for example, by specifically enabling or disabling sharing of certain information in the user's profile with the dynamic firewall system 230.

In embodiments, each subscriber or other user has an individualized security needs profile. The profile is maintained with the dynamic firewall system 230. The profile may specify device types, geographic locations, and other pertinent information. For example, if the user's role involves security threat assessment for the user's employer and that requires receiving and analyzing many suspicious email messages, the profile will reflect that. The dynamic firewall system 230 may respond by merely providing advice when a suspicious message is detected. In contrast, for another user in another roll, the dynamic firewall system 230 may respond by blocking all incoming messages from a suspicious source after a threat is detected.

Further, in some embodiments, each subscriber or user is able to determine the level of traffic access and visibility to the dynamic firewall system 230. For example, some users may prefer for the dynamic firewall system 230 to only inspect encrypted traffic for malicious patterns and volume without decrypting the traffic. Other users prefer the dynamic firewall system 230 to decrypt the traffic and provide deep packet inspection. In one example, the user may prefer that communications with family members be transmitted in the clear rather than encrypted. In another example, the user communicates via a smartphone with an IoT device in the user's home and may prefer no firewall protection for these communications. These user preference may be established in the user profile.

In some embodiments, once a subscriber or user enters a coverage area of the dynamic firewall system 230, the user communicates with the dynamic firewall system 230. For example, the dynamic firewall system 230 may broadcast its presence along with a cellular heartbeat. The heartbeat is a periodic signal sent by hardware or software of a device to the network to indicate normal operation to the network. When the dynamic firewall system 230 detects the presence of the user, the dynamic firewall system 230 will invoke the user's profile and offer tailored firewall services for that particular user while in the coverage area. In examples, as a subscriber travels, the local firewall module on the user's devices will attempt to find an existing dynamic firewall established by the firewall service. If located, the user's device will join the existing dynamic firewall according to the terms of the user's subscription and profile. If no existing dynamic firewall is located, the dynamic firewall system 230 operates to instantiate a dynamic firewall for that user.

In embodiments, if there are no users in the coverage area, the dynamic firewall system 230 will discard the local firewall until users come again to the coverage area. For example, a shell local dynamic firewall application in the edge node observes the presence of a subscriber or other user and spins up a full blown local dynamic firewall at that edge node. In effect, the local dynamic firewall lies dormant until a subscriber is again present, and the firewall is needed again. When the local dynamic firewall is spun up or instantiated again, the dynamic firewall system 230 retrieves the subscriber's subscription information and profile and tailors the local dynamic firewall to the user's preferences, device requirements and the geographical area.

In the case peer to peer communications, the user equipment devices may opt to have a copy of the traffic to be conveyed to the dynamic firewall system 230 for inspection and validation. This may be limited to communications for which decryption is allowed and decryption keys are shared with the dynamic firewall system 230.

FIG. 2C is a diagram illustrating an example, non-limiting embodiment of a mobile communication system 250 in accordance with various aspects described herein. The mobile communication system 250 may implement, for example, a 5G cellular network. The mobile communication system 250 in the illustrated embodiment includes control plane functions 252, user plane functions 254 and a dynamic firewall system 256. The dynamic firewall system 256 communicates with the control plane functions 252 and the user plane functions 254 to implement dynamic firewall services as described herein. The control plane functions 252 generally implement a core network for the mobile communications system 250. The various functional blocks of the mobile communication system 250 are communicatively connected by standard data communication interfaces labelled, for example, N1 through N8, N10 through N15 and N22 in the drawing figure.

The control plane functions 252 in the illustrated example includes a unified data management (UDM) 258, a policy control function (PCF) 260, a network slice selection function (NSSF) 262, an authentication server function 264, an access and mobility management function (AMF) 266, and a secure management function (SMF) 268. An application function (AF) 270 is in communication with the control plane functions 252. The user plane functions 254 communicate with a radio access network (RAN) 272. The RAN 271 includes one or more base stations such as gNodeB (gNB) 272. The gNodeB 272 provides wireless communications to user equipment (UE) devices 274. A local dynamic firewall module 276 is associated with the gNodeB 272 or, in some embodiments, an edge node. The operation of the control plane functions 252 and the user plane functions 254 may be generally conventional, in accordance with published air interface standards. The local dynamic firewall module 276 operates in conjunction with the dynamic firewall system 256 to implement dynamic firewall services as described herein.

The control plane functions 252 and the user plane functions 254 operate to manage quality of service (QoS) for the UE devices 274. In mobile communication system 250, QoS controls performance, reliability and usability of a telecommunications service. One aspect of QoS is prioritizing users in a network. For example, based on assigned QoS, first responders generally have the highest priority for having calls completed, relative to other users. QoS handling for the user plane, such as uplink and downlink rate enforcement, is reflective of QoS marking by the network in the downlink.

The dynamic firewall system 256 is in data communication with the control plane functions 252 and with the user plane functions 254. In the example the dynamic firewall system 256 includes subscriber profiles 278 and ML/AI function 280. As indicated, the subscriber profiles define information about preferences of subscribers to the firewall service provided by the dynamic firewall system 256. A user accessing a user device such as UE devices 274 may establish a subscriber profile, may update and modify the subscriber profile, and define the level of protection and types of protection to be provided by the firewall services. The ML/AI function operates to receive data for any suitable source and to predict possible threats to data security for subscribers and for the network. As new data are received, the ML/AI function is updated to reflect the new learnings. For example, machine learning models may be retrained on updated or newly received data in order to keep the models fresh.

The user plane functions 254 have four distinct reference points. First, an N3 interface forms a connection between gNB devices such as the gNodeB 272 in the RAN 271 and the UPF 254. Second, an N4 interface forms the connection between the SMF 268 and the UPF 254. Third, an N6 interface forms the connection between a data network and the UPF 254. The data network may be, for example, the public internet. Fourth, an N9 interface forms the connection between the UPF 254 and a second UPF (not shown in FIG. 2C).

In accordance with aspects described herein, whatever actions are taken on data processing occurring in the firewall, the quality of service for a user is generally not affected. Communication in the mobility network generally occurs between the gNodeB 272 and the UPF 254. Thus, the dynamic firewall module 276 coordinates with the UPF 254 to see if there is any unacceptable delay occurring. The UPF 254 is more traffic aware than the know the than the RAN 271 and the gNodeB 272. The UPF 254 is more aware of user experience issues such as page load time for a download of data from the internet to a UE.

Thus, the dynamic firewall 276 communicates with the UPF 254 to ensure that operation of the dynamic firewall 276 does not affect QoS for the user or any other user. If a negative effect on QoS is reported by the UPF 254 to the dynamic firewall 276, the dynamic firewall 276 automatically adjusts its operation to minimize the effect. For example, the dynamic firewall will review fewer data packets or look for only high priority threats to data security. This will reduce network traffic, free up resources, and reduce impact on QoS.

In one example, if a negative effect on QoS is reported by the UPF 254 to the dynamic firewall 276, the dynamic firewall 276 will inquire what process is being performed by the UE device 274. If, in the example, the user of the UE device 274 is downloading a data file such as streaming content, the dynamic firewall may stop checking all packets for possible threats. In that situation, there is a statistical likelihood that no threat will be discovered during the data download. In an alternative, the dynamic firewall 276 may be informed that the user is viewing a film from a known-suspicious website that has been the source of data attacks or spreading viruses in the past. In that circumstance, the dynamic firewall 276 may decide to watch the download closely for suspicious activity, at the risk of negatively affecting QoS.

In a second aspect, the AMF 266 forms an access point to the core network of the mobile communications system 250. Base stations such as the gNodeB 272 and other devices communicate through the AMF 266. The AMF 266 confirms that the user is suitable authorized for access to the mobile communications system 250. The dynamic firewall 276 cooperates with the AMF 266 (through the gNodeB or through an edge node) to ensure that network policies for access by a UE device are followed. Thus, the dynamic firewall 276 protects the network in two ways. First, it protects the UPF 254 by getting the context of the communication by the UE device 274. And it protects the 5G core via the AMF 266.

Accordingly, the embodiments described herein relate to an Intelligent Dynamic Firewall (IDFW) that may be deployed autonomously in a geographical area, in a distributed manner, and resides with the RAN or edge node electronics. The firewall covers the many communication types, including for example, nodes, such as cars, IoT devices, smartphones, core peer to peer communications, such as car to car, IoT to Car, between IoT devices. The IDFW may be spun up or instantiated by a backend orchestrator's main application in collaboration with a local module that resides on the edge nodes. The IDFW recognizes subscribers who are registered to use the firewall service. Each subscriber has a unique profile including security needs and traffic requirements.

FIG. 2D and FIG. 2E depicts an illustrative embodiment of a method 282 in accordance with various aspects described herein. The method 282 may be performed by a dynamic firewall system including a central firewall controller such as the backend orchestrator 212 of FIG. 2A, operating in conjunction with one or more Intelligent Dynamic Firewall (IDFW) modules associated with an edge node, base station or other infrastructure element of a mobility network.

At block 283, the IDFW module detects a user device in the vicinity of the edge node or base station or edge node where the IDFW module resides. This may be done in any suitable manner. In one example, the IDFW module monitors all user equipment (UE) devices that attach to the base station or the edge node. For example, attachment may include providing identifying information for the UE device such as a mobile phone number of international mobile equipment identifier (IMEI). The IDFW module may compare such identifiers with a list of subscribers to the firewall service. The IDFW module may communicate with the central firewall controller to obtain the list of subscribers.

If the UE identifier is on the list of subscribers and the UE device is part of a subscription to the firewall service, the IDFW module may retrieve a subscriber profile from the central firewall controller. The subscriber profile in embodiments identifies user preferences for the firewall service for the UE device. Further, the subscriber profile identifies a level of traffic access and visibility to be applied by the dynamic firewall system. For example, some subscribers want the IDFW to only inspect encrypted traffic for malicious patterns and volume without decrypting the traffic. Similarly, other subscribers want the IDFW to decrypt the traffic and provide deep packet inspection.

The subscriber profile may be established by the user in any suitable manner. In some embodiments, the user may be presented with a website and given options for defining the level and type of firewall protection given to the user. This may be appropriate for defining firewall protection for devices with limited user interface capabilities such as an IoT device. In other examples, an application may be loaded on the user's device such as a smartphone or laptop computer. The user may interact with the user interface to define firewall protection. Moreover, the user may interact with the website or application or other channel to define security and firewall protection for a number of devices controlled by the user. In embodiments, the firewall service may be available as a subscription for a fee to subscribers and offered by the operator of the mobility network. The subscription may define various levels of protection and various protected devices, with levels of protection available according to a schedule of subscription fees.

At block 284, the method 282 includes setting protection for the user device according to the profile retrieved at block 283. Setting protection may include establishing security procedures to be followed for the UE device by the IDFW module at the edge node where the user device is attached as well as setting procedures to be followed at the central firewall controller. Further, setting protection may further include initiating collection of data about activity by the user, activity related to the user's level of protection, activity related to detection of security threats, etc. The collected data may be automatically reported back to a machine learning or artificial intelligence process operating at the central firewall controller for evaluation and detection of possible security threats to the user device.

At block 285, the method 281 includes determining if the subscriber has other devices associated with the subscriber or the subscription. If not, control proceeds to step 287. If the user does have other user devices, at step 286, protection is added according to the user profile or subscription profile. For example, the user may have one security profile selected for a mobile device that travels with the user to different geographic areas, and a second profile selected for an IoT device that is secured at the user's residence. At step 287, the level of protection for the additional user devices is set by the IDFW module and the central firewall controller.

At step 288, the method 282 determines if there is an update to the user profile from the subscriber. For example, the user may dynamically adjust the level or protection afforded to one or more of the user's subscribed devices. The user may increase protection for mobile devices that are more subject to outside communications which may possibly be malicious, while reducing firewall protection for IoT devices in a business owned by the user. The user may, for example, interact with a user interface such as on a website or a mobile application to update the user's profile or subscription settings. At step 289, the user's profile is adjusted or updated to reflect changes may be the user. If appropriate, the current protections specified by the user are updated based on the update profile and at step 290, the method 282 includes setting protection for the users' devices. Control proceeds to FIG. 2E as indicated.

FIG. 2E illustrates ongoing operation of the dynamic firewall system. At block 291, the method 282 includes collecting data from a variety of sources and reporting the data to a machine learning model or artificial intelligence process, generally called a ML/AI function. In embodiments, the ML/AI function receives information from available sources that are related to firewall services or security functions. Such sources may include IDFW modules located at individual edge nodes. Such sources may include other services that monitor potential threats and provide data to assist in identifying such threats. An example is a firewall system that shares network address and other information of a website that spreads viruses or attempts DDoS attacks.

The ML/AI function further uses the collected information to identify security threats that may affect a protected device, to develop a response to the threat, and to provide information and commands to local firewall modules at individual devices to protect against the threat. For example, each local firewall module reports to the ML/AI function all pertinent information the local firewall module receives, about activity performed by a protected device, about data communication traffic received at and transmitted from the protected device and even environmental information about a protected device. In one example the local firewall module for a connected vehicle may report information about current vehicular traffic experienced by the connected vehicle. Such information is collected by and processed by the ML/AI function at the central firewall controller to identify patterns in the information. Moreover, the ML/AI function may have access to information stored on user devices, such as a user's messages and email, a user's calendar and contacts. This information may be processed by the ML/AI function to identify potential or future threats which may affect a device of the user.

The ML/AI function may be implemented in any suitable manner. In one example, the ML/AI function includes a machine learning model which is trained on historical threat data and used for pattern matching with current user device activity to identify potential threats. As new threats are identified, the new threat information is used at block 291 to periodically re-train the machine learning model in order to update the machine learning model to reflect and detect the latest attempts to circumvent the dynamic firewall system 230.

At step 292, the method 282 determines if a possible threat has been identified. The identification may be probability based, such as being based on a confidence level compared with a threshold. For example, if the ML model concludes that a particular contact represents a 75% likelihood of being threat, that confidence level may be compared with a threat threshold such as 80%. If the confidence level does not equal or exceed the threat threshold, no further action may be taken, but the risk may be noted by the ML model and used to evaluate future threats. In some embodiments, the threat threshold may be variable based on any suitable factor. For example, a particularly dangerous threat such as a virus that maliciously deletes data may be considered very dangerous and may be evaluated against a relatively low threshold. On the other hand, a less malicious threat may be evaluated as less dangerous and will be evaluated against a higher threshold. Further, the threshold may be varied based on current circumstances, such as an ongoing data stream from a known source. Any threat detected in that circumstance may have a high threshold, so that the ML model should have a high degree of confidence before the streaming operation is interrupted.

Threats may be of any sort that a firewall can detect and block, such as invasive computer viruses, phishing requests, and any improper or unauthorized contacts. At step 293, if a possible threat is detected, the method 282 includes adapting to the identified threat. Any suitable or appropriate adaptation may be taken. This may include blocking further access by a server or device, temporarily suspending communication with an email account that is sending viruses, etc.

At step 294, the method 282 includes determining if peer to peer communication should be monitored. Such peer-to-peer communications may include email or text messages, for example. In another example, a connected car uses sidelink communications to interact with another vehicle, person or roadside infrastructure. A user or subscriber may select to have such peer-to-peer communications monitored, for example by specifying details in the user profile. If peer to peer monitoring is selected and such a communication is received, at block 295, the communication is forwarded by the local dynamic firewall module to the central firewall controller for inspection. If appropriate, suitable protective measures may be taken. In some cases, this may require sharing of users' encryption keys and decryption of the communication.

At step 296, the method 282 determines if there is no subscriber UE currently in the coverage area. For example, a mobile subscriber may leave the geographic area for which firewall protection is provided, such as by travelling out of the coverage area of a base station to a new coverage area of an adjacent base station. The firewall protection will begin in the new coverage area (as illustrated at block 283, FIG. 2D. However, in the old coverage area, the local IDFW instantiation will be discarded or suspended. In an example, the IDFW module will discard itself until users return to the coverage area. Control may the proceed to block 283 and a shell IDFW application in the edge node will observe the presence of a new subscriber and will spin up a full blown IDFW module.

While for purposes of simplicity of explanation, the respective processes are shown and described as a series of blocks in FIG. 2D and FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

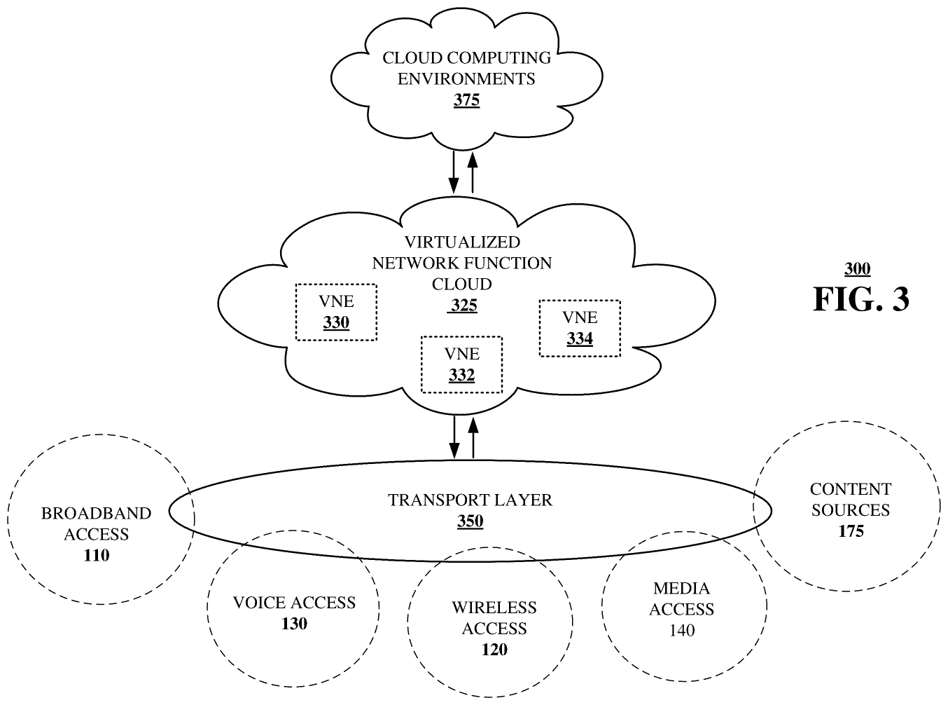

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, and method 282 presented in FIG. 1, FIG. 2A, FIG. 2B, FIG. 2C, FIG. 2D, FIG. 2E, and FIG. 3. For example, virtualized communication network 300 can facilitate in whole or in part establishing a local dynamic firewall for subscribers that interacts with a backend orchestrator to dynamically create and update a firewall service. The firewall service moves with and adapts to the activity of the user device.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

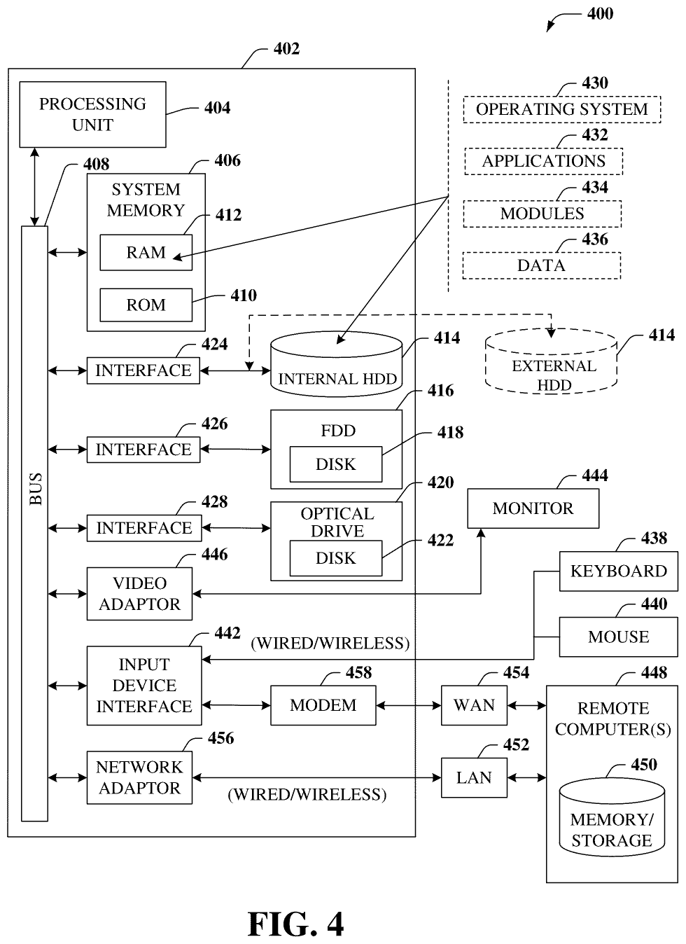

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part establishing a local dynamic firewall for subscribers that interacts with a backend orchestrator, which may be implemented along the lines of the computing environment, to dynamically create and update a firewall service. The firewall service moves with and adapts to the activity of the user device.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

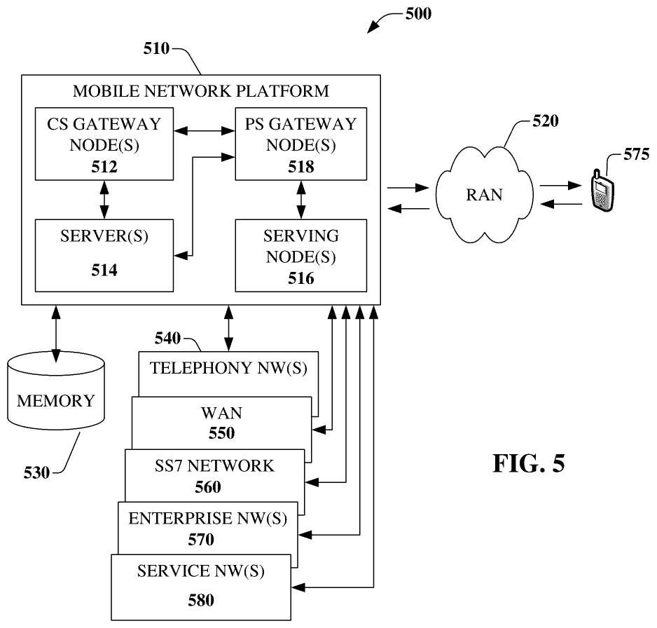

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part establishing a local dynamic firewall for subscribers that interacts with a backend orchestrator to dynamically create and update a firewall service. For example, the local firewall module may be integrated with or communicate with the mobile network platform 510. The firewall service moves with and adapts to the activity of the user device. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

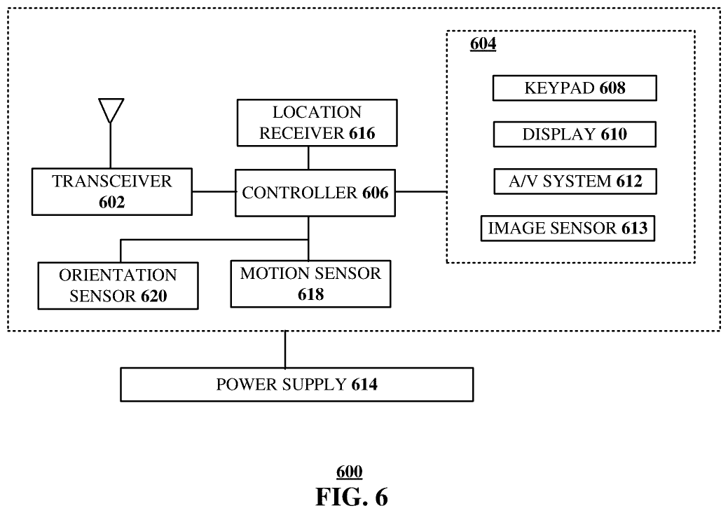

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part establishing a local dynamic firewall for subscribers that interacts with a backend orchestrator to dynamically create and update a firewall service. The firewall service moves with and adapts to the activity of the user device, which may be embodied in accordance with communication device 600, for example.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and cast, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, X=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
instantiating, by a processing system including a processor, a local firewall module at a network node of a mobility network, the network node providing communication services to a service area;
detecting, by the processing system, presence of a subscriber device in the service area;
retrieving, by the processing system, a subscriber profile for the subscriber device from a central firewall controller, wherein the retrieving is responsive to the detecting the presence of the subscriber device in the service area and wherein the central firewall controller cooperates with the local firewall module to provide firewall services for the subscriber device according to the subscriber profile;
detecting, by the processing system, communication activity of the subscriber device;
communicating, by the processing system, information about the communication activity of the subscriber device to the central firewall controller;
receiving, by the processing system, information defining a threat response from the central firewall controller, the information defining the threat response determined by the central firewall controller responsive to the communication activity of the subscriber device and additional information related to possible security threats collected by the central firewall controller; and
modifying, by the processing system, communication activities of the subscriber device based on the information defining the threat response from the central firewall controller.

2. The method of claim 1, wherein the detecting communication activity of the subscriber device comprises:
detecting, by the processing system, communications between the subscriber device and a core of the mobility network.

3. The method of claim 1, wherein the detecting communication activity of the subscriber device comprises:
detecting, by the processing system, peer-to-peer communications between the subscriber device and a second user device.

4. The method of claim 3, wherein the detecting peer-to-peer communications comprises:
detecting, by the processing system, a sidelink communication between the subscriber device and the second user device.

5. The method of claim 1, comprising:
identifying, by the processing system, one or more other subscriber devices associated with the subscriber profile; and
extending, by the processing system, the firewall services for the subscriber device to the one or more other subscriber devices according to the subscriber profile.

6. The method of claim 5, further comprising:
communicating, by the processing system, with a second local firewall module to provide the firewall services for one or more other subscriber devices, the second local firewall serving a geographic area occupied by at least one subscriber device of the one or more other subscriber devices.

7. The method of claim 1, comprising:
receiving, by the processing system, profile updates for the subscriber profile; and
updating, by the processing system, the subscriber profile based on the profile updates.

8. The method of claim 7, comprising:
modifying, by the processing system, the firewall services based on the profile updates.

9. The method of claim 1, wherein the receiving information defining a threat response from the central firewall controller comprises:
receiving, by the processing system, information about a prediction of future security threats to the subscriber device, the prediction of future security threats developed by a machine learning module responsive to the communication activity of the subscriber device and the additional information related to possible security threats.

10. The method of claim 1, wherein the modifying the communication activities of the subscriber device comprises:
blocking, by the processing system, access to a suspected network location by the subscriber device to prevent a malware attack on the subscriber device.

11. A device, comprising:
a processing system including a processor; and
a memory that stores executable instructions that, when executed by the processing system, facilitate performance of operations, the operations comprising:
instantiating a local dynamic firewall module at a network node of a mobility network, the local dynamic firewall module providing firewall services to a firewall service area;
detecting communication activity of a subscriber device, the subscriber device having a subscription to the firewall services;
communicating information about the communication activity of the subscriber device to a central firewall controller;
receiving, from the central firewall controller, information defining a threat response, the information defining the threat response determined by the central firewall controller responsive to the communication activity of the subscriber device, a subscriber profile associated with the subscription to the firewall services, and additional information related to possible security threats detected by the central firewall controller; and
limiting communication activities of the subscriber device based on the information defining the threat response from the central firewall controller.

12. The device of claim 11, wherein the operations further comprise:
identifying one or more other subscriber devices associated with the subscription to the firewall services;
extending the firewall service area to include geographic areas where the one or more other subscriber devices are located to provide the firewall services to the one or more other subscriber devices; and
modifying the firewall service area in response to movement and activities of the subscriber device and the one or more other subscriber devices.

13. The device of claim 12, wherein the operations further comprise:
receiving updates to the subscriber profile associated with the subscription to the firewall services;
modifying the subscriber profile; and
modifying the firewall services in response to the modifying the subscriber profile.

14. The device of claim 13, wherein the receiving updates to the subscriber profile comprises:
providing a user interface to a user associated with the subscriber device;
receiving user information from the user, wherein the user information defines security and firewall protection for the subscriber device and the one or more other subscriber devices; and
modifying the subscriber profile based on the information defining security and firewall protection.

15. The device of claim 11, wherein the receiving information defining a threat response from the central firewall controller comprises:
receiving information tailored to operational capabilities of the subscriber device to avoid a security threat associated with the threat response.

16. A non-transitory machine-readable medium, comprising executable instructions that, when executed by a processing system including a processor, facilitate performance of operations, the operations comprising:
receiving information about a subscriber device in a mobility network;
communicating, to an edge node, information to establish at the edge node a local dynamic firewall for the subscriber device;
receiving, from the edge node, information about communication activities of the subscriber device;
identifying a security threat to the subscriber device, wherein the identifying the security threat is responsive to the information about communication activities of the subscriber device and information about other security threats identified in the mobility network;
determining a threat response for the subscriber device, wherein the threat response is intended to avoid malicious effects of the security threat to the subscriber device; and
communicating information about the threat response to the subscriber device.

17. The non-transitory machine-readable medium of claim 16, wherein the operations further comprise:
implementing a machine learning or artificial intelligence (ML/AI) function;
collecting threat information from available sources about possible security threats in the mobility network; and
based on the threat information, identifying security threats that may affect protected devices including the subscriber device.

18. The non-transitory machine-readable medium of claim 17, wherein the operations further comprise:
receiving additional information about subsequently occurring security threats to protected devices; and
updating the ML/AI function based on the additional information to maintain currency for the ML/AI function.

19. The non-transitory machine-readable medium of claim 16, wherein the operations further comprise:
retrieving a security profile for the subscriber device; and
determining the threat response for the subscriber device based on the security profile.

20. The non-transitory machine-readable medium of claim 16, wherein the operations further comprise:
instantiating a local dynamic firewall module at a network node of the mobility network, the local dynamic firewall module providing firewall services for the subscriber device to a firewall service area, the firewall service area including a geographic area containing the subscriber device; and
modifying the firewall service area responsive to movement and activities of the subscriber device.
